(19) United States
(12) Patent Application Publication
(10) Pub. No.: US 2014/0358508 A1
(43) Pub. Date: Dec. 4, 2014

(54) Method for Optimizing HVAC Systems in Buildings Using Nonlinear Programming to Maximize Comfort for Occupants

(71) Applicant: Mitsubishi Electric Research Laboratories, Inc., Cambridge, MA (US)

(72) Inventors: Arvind U. Raghunathan, Brookline, MA (US); Daniel N. Nikovski, Brookline, MA (US)

(73) Assignee: Mitsubishi Electric Research Laboratories, Inc., Cambridge, MA (US)

(21) Appl. No.: 13/903,032

(22) Filed: May 28, 2013

(51) Int. Cl. G06F 17/50; F24F 11/00

(52) U.S. Cl. CPC G06F 17/5009; F24F 11/0009
USPC 703/7

(57) ABSTRACT

A heating, ventilation and air-conditioning (HVAC) system for a building is optimized while maximizing a comfort of occupants and minimizing energy consumption. The building is modeled as a network of nodes and edges, wherein the nodes represent rooms, and the edges represent walls. Dynamics of temperatures and humidity in the rooms and the temperature of the walls and the building are modeled using differential equations and the network. The comfort of the occupants is modeled by a predicted mean vote (PMV). The minimizing is formulated as an optimal control problem, which is discretized using an integration technique to obtain a finite dimensional optimization problem. Then, the finite dimensional optimization problem is solved using sparse linear algebra until convergence.

### FIELD OF THE INVENTION

The present invention relates generally to controlling heating, ventilation and air conditioning (HVAC) systems in buildings, and more particularly to maximizing comfort for building occupants.

### BACKGROUND OF THE INVENTION

The comfort of building occupants must be maximized while minimizing energy costs. Most conventional strategies for operating HVAC systems:

(i) Do not consider the entire system. For instance, the control over multiple rooms in the building is usually decoupled to yield smaller loops over which the control actions are independently solved. This approach fails to consider the full coupling between the subsystems and can lead to poor performance.
(ii) Do not consider thermal and humidity dynamics of the building that predict the evolution of temperature humidity over time.
(iii) Do not consider occupant comfort metrics, such as a predicted mean vote (PMV), or thermal comfort zones during the determination of the operational strategies, and instead employ set-point based strategies. This can lead to increased energy consumption and discomfort for the occupants.

Most model based optimization approaches for determining the HVAC operational strategies:

(i) Employ linear programming for the optimization, which can fail to fully model the complete dynamics of the system.
(ii) Do not include constraints on thermal comfort, such as the PMV, and instead rely on set-points for temperature. This can result in increased energy costs.
(iii) When the PMV is used, the model is simplified by linearizing the system equation, which leads to inaccuracies in estimating the true comfort of the occupants. This can result in increased discomfort for the occupants.

Thus, there is a need to optimize a building HVAC system, and to consider accurate models of occupant comfort and building thermal and humidity dynamics.

### SUMMARY OF THE INVENTION

The embodiments of the invention provide a method for determining an optimal operation of a HVAC system by minimizing energy consumption, while maximizing occupant comfort. The building dynamics are modeled using differential equations that control an evolution of temperatures and humidity in rooms. An energy consumption of the HVAC system is modeled using steady state equations, or differential equations. The occupant comfort is measured using comfort indices such as a predicted mean vote (PMV).

The PMV determinations involve conditional statements, which result in nonsmooth behavior. Several embodiments for reformulating the conditional statements to computationally tractable forms that are suitable for optimization are provided. A nonlinear program incorporating sparse linear algebra is used to ensure computational efficiency of the method.

### BRIEF DESCRIPTION OF THE DRAWINGS

FIG. 1 is floor plan of a building with indoor air conditioners installed in each room and connected with an outdoor unit;

FIG. 2A is the floor plan with numbered rooms;

FIG. 2B is a graphical representation of the rooms with nodes representing rooms, and edges representing rooms that share a common wall;

FIG. 3A is a resistor-capacitor representation of the thermal dynamics of room air;

FIG. 3B is a resistor-capacitor representation of the thermal dynamics of the wall in the room;

FIG. 3C is a resistor-capacitor representation of the humidity dynamics of room air;

FIG. 4 is a flowchart of a method for determining optimal operation of an HVAC system; and

FIG. 5 is a block diagram of a procedure for minimizing electric power consumption of the outdoor unit according to embodiments of the invention.

### DETAILED DESCRIPTION OF THE PREFERRED EMBODIMENTS

Building Representation

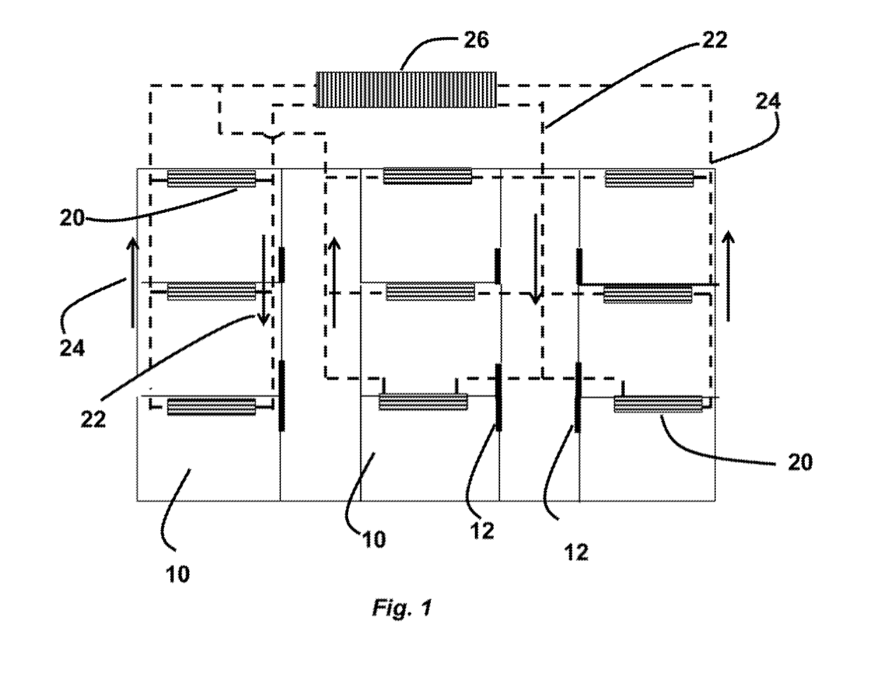

FIG. 1 shows a floor plan for a building that can be used by embodiments of our invention. The building includes rooms 10 and doors 12. Each room is equipped with an indoor air conditioning unit 20. The indoor units are connected to an outdoor unit 26. A refrigerant is used for cooling or heating room air flows 22 to the indoor units from the outdoor unit. The refrigerant flows (dashed lines) 24 from the indoor unit to the outdoor unit where the heat is dissipated and the refrigerant is recycled back to the indoor unit 22.

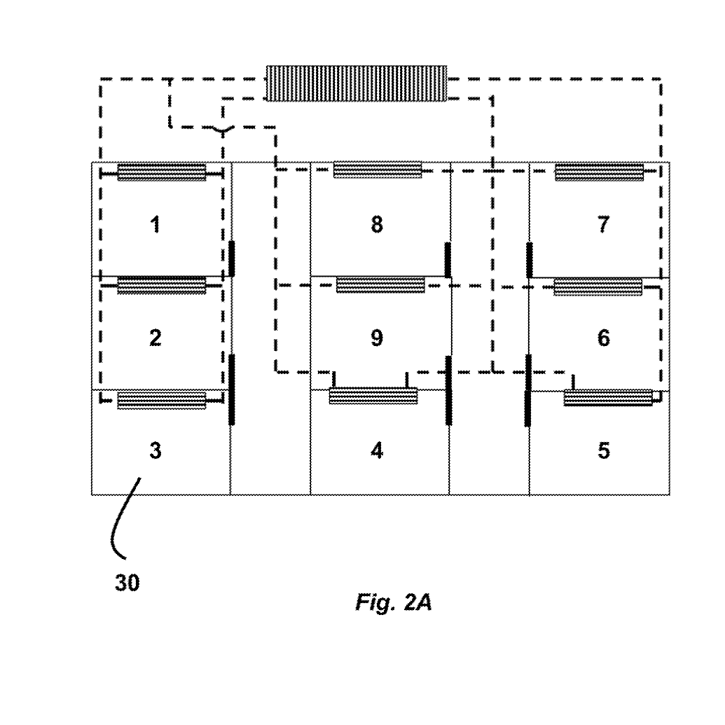

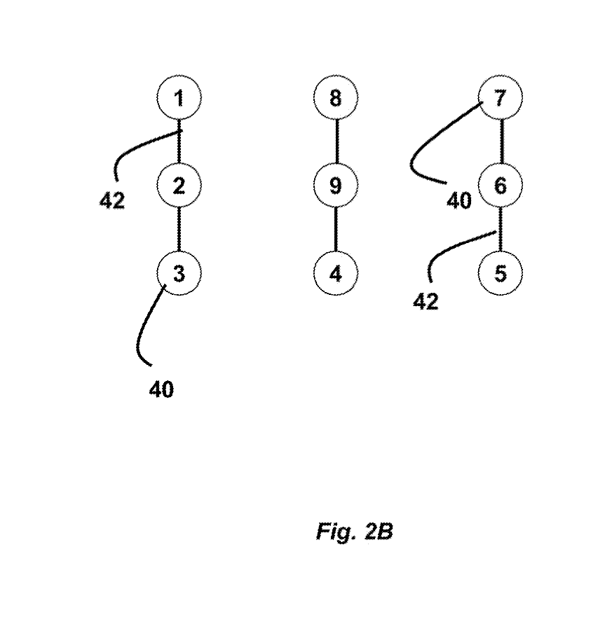

FIG. 2A shows a numbering of nine rooms 30 in the building, i.e., 1 to 9. The graph network representation in FIG. 2B based on this numbering. Nodes 40 represent the rooms in the building, and edges 42 represent the rooms that share a wall.

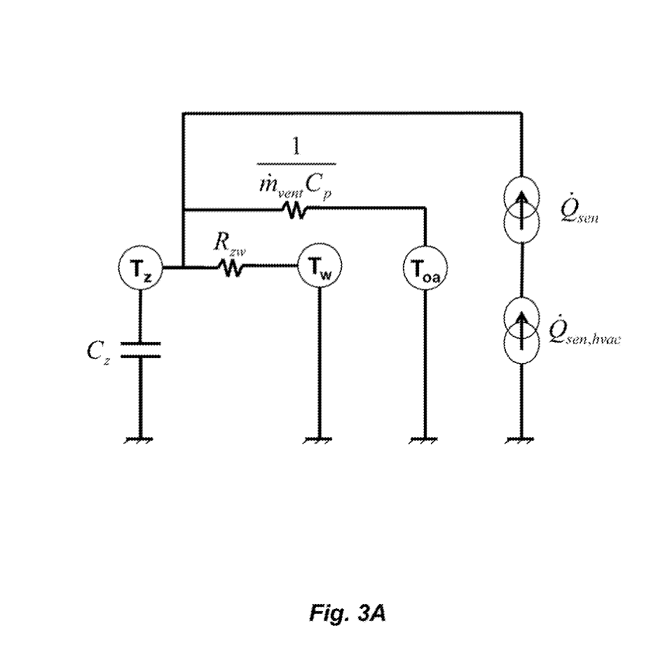

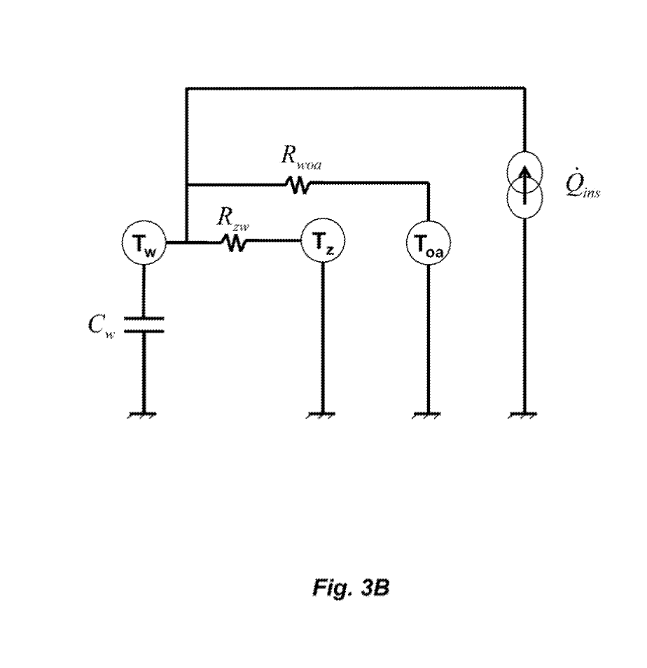

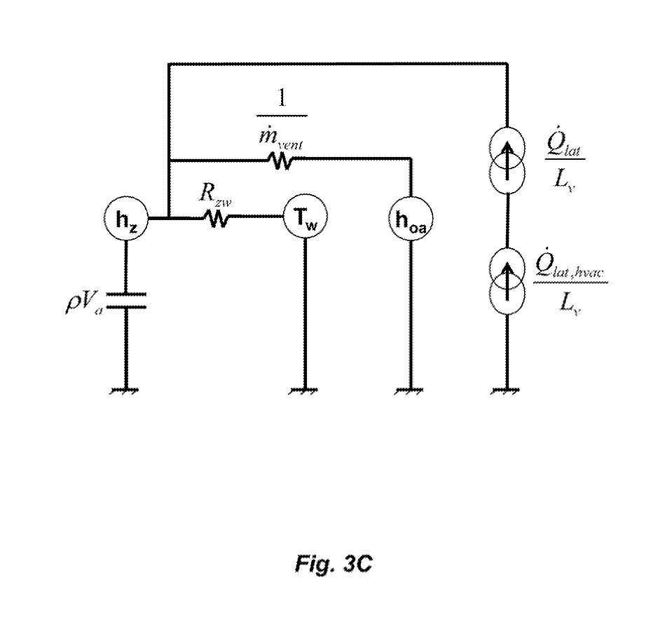

FIG. 3A provides a resistive capacitive network representation of the building model for thermal and humidity dynamics. The variables used in this figure and other similar figures are described in detail below.

Input

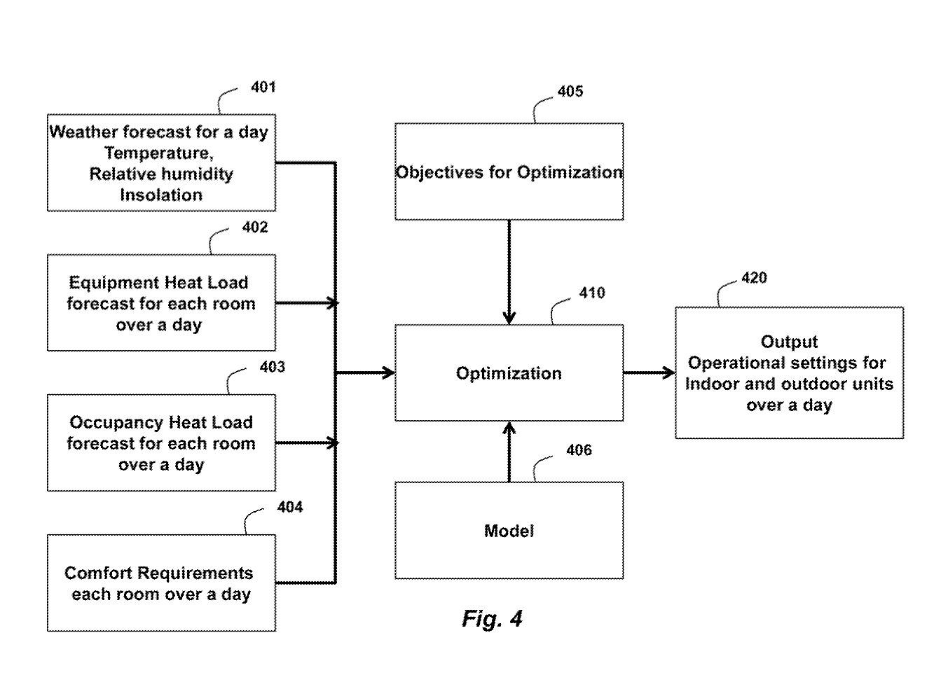

As shown in FIG. 4, input to the optimization method 410 includes the following for a time period:

Forecast 401 of hourly weather pattern.

Equipment heat load forecast 402 for each room.

Prediction 403 of the occupant heat loads.

Comfort requirements 404 for the occupants.

Objectives 405 of the optimization.

The method uses objectives for the optimization 405 and a model 406.

The steps of the method as described herein can be performed in a processor connected to a memory, and input and output interfaces as known in the art.

Output

Output 420 of the method includes a time profile of control variables in the model which can include: compressor frequency, air flow rate from each room through the conditioner, and the evolution of the temperatures of the room, temperatures of the walls and humidity in the rooms as a result of choice of prescribed control actions. All temperatures are in degrees centigrade.

Room Dynamics Model

In the preferred embodiment, the dynamics of the room are modeled as a set of differential equations. A linear resistive capacity circuit modeling the room temperature dynamics is shown in FIG. 3A. The thermal dynamics of the room is modeled as

$$\frac{d {T}_{z}}{d t} = \frac{{T}_{w} - {T}_{z}}{{C}_{z} {R}_{zw}} + \frac{{\dot{m}}_{vent} {C}_{p} ( {T}_{oa} - {T}_{z} )}{{C}_{z}} + \frac{{\dot{Q}}_{sen}}{{C}_{z}} + \frac{{\dot{Q}}_{sen , hvac}}{{C}_{z}} , \qquad ( 1 )$$

where T_{z} is the temperature of the room in degrees centigrade, T_{w} is the temperature of wall in the room, C_{z} is the heat capacity of the room air in Joules (J) per kilogram (kg), R_{zw} is the resistance for heat transfer between the zone air and the walls of the zone, Tₒₒ is the ambient air temperature, Cₚ is the specific heat capacity of air in (J/kg/K), \dot{m}ᵥₑₙₜ is the flow rate of ventilation air in (kg/s), \dot{Q}ₛₑₙ is a rate of sensible heat generated by equipment, occupants in the room and solar radiation through windows, \dot{Q}_{sen,hvac} is a rate of sensible heat transferred to the room air from the indoor air conditioning unit. The dot above the variables indicates the first derivative with respect to time.

The linear resistive capacity circuit modeling the temperature dynamics of the room wall is shown in FIG. 3B. The thermal dynamics of the wall in the room is modeled as

$$\frac{d {T}_{w}}{d t} = \frac{{T}_{z} - {T}_{w}}{{C}_{w} {R}_{zw}} + \frac{{T}_{oa} - {T}_{w}}{{C}_{w} {R}_{woa}} + \frac{{\dot{Q}}_{ins}}{{C}_{w}} , \qquad ( 2 )$$

where C_{w} is the heat capacity of the wall in (J/k), R_{woa} is the resistance for heat transfer between the wall and ambient air and \dot{Q}ᵢₙᵥ is the rate of heat transfer from solar radiation to the wall in (W).

The linear resistive capacity circuit modeling the room humidity dynamics is shown in FIG. 3C. The humidity dynamics of the room air is modeled as

$$\frac{d {h}_{z}}{d t} = \frac{{\dot{m}}_{vent} ( {h}_{oa} - {h}_{z} )}{ρ {V}_{a}} + \frac{{\dot{Q}}_{lat}}{ρ {V}_{a} {L}_{v}} + \frac{{\dot{Q}}_{lat , hvac}}{ρ {V}_{a} {L}_{v}} , \qquad ( 3 )$$

where h_{z} is the specific humidity of zone air in (kg/kg), ρ is the density of air, Vₐ is the volume of air in the room, L is the latent heat of evaporation of water in (J/kg), \dot{Q}ₗₐₜ is the rate of latent heat generated by equipment and occupants in the room in (W) and \dot{Q}_{lat,hvac} is the rate of latent heat added to the room air by the indoor air conditioning unit.

Predicted Mean Vote

In the preferred embodiment, a predicted mean vote (PMV) is used to measure the occupant comfort, see ANSI/ASHRAE Standard 55-2010, Thermal Environmental Conditions for Human Occupancy. The PMV includes parameters that influence comfort: temperature, relative humidity, air velocity, metabolic rate, mean radiant temperature, and clothing insulation. The PMV measures the thermal comfort of the occupants on a scale of −3 to +−3 with: −3: very cold, −2: cold, −1: slightly cool, 0: neutral, +1: slightly warm, +2: warm, +3: hot. The typical range for different building types is prescribed in the American Society of Heating, Refrigerating and Air-Conditioning Engineers (ASHRAE) standard ISO 7730:2005.

The PMV is determined by the following equations:

$$\begin{matrix}PMV = ( 0.303 {e}^{- 0.036 M} + 0.028 ) [ ( M - W ) - 3.05 \times {10}^{- 3} ( 5733 - 6.999 ( M - W ) - {p}_{a} ) - 0.42 ( ( M - W ) - 58.15 ) - 1.7 \times {10}^{- 5} M ( 5867 - {p}_{a} ) - 0.0014 M ( 34 - {T}_{z} ) - 3.96 \times {10}^{- 8} {f}_{cl} ( {( {T}_{cl} + 273.15 )}^{4} - {( {\overline{T}}_{r} + 273.15 )}^{4} ) - {f}_{cl} {h}_{c} ( {T}_{cl} - {T}_{z} ) ] , & ( 4 ) \\ {T}_{cl} = 35.7 - 0.028 ( M - W ) - 3.96 \times {10}^{- 8} {I}_{cl} {f}_{cl} ( {( {T}_{cl} + 273.15 )}^{4} - {( {\overline{T}}_{r} + 273.15 )}^{4} ) + {I}_{cl} {f}_{cl} {h}_{c} ( {T}_{cl} - {T}_{z} ) , & ( 5 ) \\ {h}_{c} = \{ \begin{matrix}2.38 {\vert {T}_{cl} - {T}_{z} \vert}^{0.25} , & if 2.38 {\vert {T}_{cl} - {T}_{z} \vert}^{0.25} > 12.1 \sqrt{{v}_{ar}} \\ 12.1 \sqrt{{v}_{ar}} , & if 2.38 {\vert {T}_{cl} - {T}_{z} \vert}^{0.25} < 12.1 \sqrt{{v}_{ar}}\end{matrix} , & ( 6 ) \\ {f}_{cl} = \{ \begin{matrix}1.00 + 1.29 {I}_{cl} , & if {I}_{cl} \leq 0.078 \\ 1.05 + 0.645 {I}_{cl} , & if {I}_{cl} > 0.078\end{matrix} , & ( 7 ) \\ {p}_{a} = \frac{{h}_{z}}{0.622 + {h}_{z}} {p}_{atm} , & ( 8 )\end{matrix}$$

where T_{z} is the temperature of the room, h_{z} is the absolute specific humidity in the room, M is the metabolic rate in (W/m²), W is the effective mechanical power in (W/m²), I_{cl} is the clothing insulation in (m²k/W), f_{cl} is the clothing area factor, T̅ᵣ is the mean radiant temperature, vₐᵣ is the relative air velocity in the room in (m/s), h_{c} is the convective heat transfer coefficient in (W/m²/K), pₐ is the water vapor partial pressure in atmospheres (atm), T_{cl} is the clothing surface temperature, and pₐₜₘ is the atmospheric pressure in (atm).

In the PMV model equations, M, W, I_{cl}, f_{cl} are parameters that are specified by the type of activity, e.g., sedentary office work, vigorous workout, that occurs in the room and clothing insulation material that is worn by the occupants in the room. These are not decision variables in the optimization problem. Although Eq. (7) has conditional statement, the value of f_{cl} can be determined a priori for the entire period over which the optimization is performed.

However, Eq. (6) involves conditional statements involving the decision variables in the optimization problem T_{z}, T_{cl}. One approach to handle this is to add binary variables to the optimization problem and express the conditional statement as

zε{0,1}

2.38|T_{cl}−T_{z}|^{0.25}≧(12.1\sqrt{vₐᵣ})z

h_{c}=(2.38|T_{cl}−T_{z}|^{0.25})z+12.1\sqrt{vₐᵣ}(1−z). (9)

If z=1 in Eq. (9), then the first condition in Eq. (6) is enforced and consequently, h_{c}=2.38|T_{cl}−T_{z}|^{0.25}. If z=0, then the second conditional in Eq. (6) is enforced and consequently, h_{c}=12.1\sqrt{vₐᵣ}. With this modification, the optimization problem using PMV indices and Eq. (9) will fall in the class of mixed integer nonlinear programs (MINLPs), which are typically computationally complex.

To address the computational intractability of binary variable based modeling, while still retaining the original PMV formulation, we pose the conditional statement as

h_{c}=max(2.38|T_{cl}−T_{z}|^{0.25},12.1\sqrt{vₐᵣ}). (10)

This expresses the conditional statement in Eq. (6) but does not allow continuous optimization because Eq. (10) is not smooth. To address this concern, we first consider the following exact reformulation:

$${h}_{c} = \frac{1}{2} ( \begin{matrix}2.38 {\vert {T}_{cl} - {T}_{z} \vert}^{0.25} + 12.1 \sqrt{{v}_{ar}} + \\ \sqrt{{( 2.38 {\vert {T}_{cl} - {T}_{z} \vert}^{0.25} - 12.1 \sqrt{{v}_{ar}} )}^{2}}\end{matrix} ) . \qquad ( 11 )$$

It can be verified in Eq. (11) that if the first conditional in Eq. (6) holds, then h_{c}=2.38|T_{cl}−T_{z}|^{0.25}. On the other hand, if the second conditional in Eq. (6) holds, then h_{c}=12.1\sqrt{vₐᵣ}. Eq. (11) is differentiable everywhere except at 2.38|T_{cl}−T_{z}|^{0.25}=12.1\sqrt{vₐᵣ} because the square root function is not differentiable at 0. This point of non-differentiability is problematic for continuous optimization. To address this concern, the smoothing procedure is applied to Eq. (11) as

$${h}_{c} = \frac{1}{2} ( \begin{matrix}2.38 {\vert {T}_{cl} - {T}_{z} \vert}^{0.25} + 12.1 \sqrt{{v}_{ar}} + \\ \sqrt{{( 2.38 {\vert {T}_{cl} - {T}_{z} \vert}^{0.25} - 12.1 \sqrt{{v}_{ar}} )}^{2} + {τ}^{2}}\end{matrix} ) , \qquad ( 12 )$$

where τ>0 is the smoothing parameter. For all τ>0. Eq. (12) is differentiable everywhere and the continuous optimization algorithms can be readily applied. Because the smoothing parameter τ>0 has to be driven to zero to recover Eq. (6), the method solves a sequence of optimization problem where the value of the smoothing parameter is monotonically decreased. This provides an accurate method for handling the nonsmooth conditional in Eq. (6) and uses continuous optimization algorithms, which are computationally efficient.

A third approach handles the nonsmooth conditionals in Eq. (10) by writing the max operator as

$$z = arg {min}_{0 \leq y \leq 1} ( - 2.38 {\vert {T}_{cl} - {T}_{z} ⌉}^{0.25} + 12.1 \sqrt{{v}_{ar}} ) y \\ {h}_{c} = ( 2.38 {\vert {T}_{cl} - {T}_{z} \vert}^{0.25} ) z + 12.1 \sqrt{{v}_{ar}} ( 1 - z ) . \qquad ( 13 )$$

In Eq. (13), if the first conditional of Eq. (6) is satisfied, then

z=1 and h_{c}=2.38|T_{cl}−T_{z}|^{0.25}

holds. If the second conditional in Eq. (6) is satisfied, then

z=0 and h_{c}=12.1\sqrt{vₐᵣ},

This formulation is still not convenient for optimization. Therefore, we replace the minimization in Eq. (13) with the first order stationary conditions as

−2.38|T_{cl}−T_{z}|^{0.25}+12.1\sqrt{vₐᵣ}−λ+v=0

λ≧0⊥z≧0

v≧0⊥z≦1

h_{c}=(2.38|T_{cl}−T_{z}|^{0.25})z+12.1\sqrt{vₐᵣ}(1−z). (14)

In Eq. (14), λ≧0⊥z≧0 is a complementarity constraint equivalent to λ, z≧0, λz=0, In other words, λ=0 or z=0. Similarly, the other complementarity condition v≧0⊥z≦1 implies that v=0 or z=1. When these two conditions are taken together it can be seen that λ, v>0 cannot occur since the complementarity conditions will imply that z=0 and z=1. If the first conditional in Eq. (6) holds, then v=12.1\sqrt{vₐᵣ}−2.38|T_{cl}−T_{z}|^{0.25} and λ=0, which implies that z=1 and h_{c}=2.38|T_{cl}−T_{z}|^{0.25} holds. The case of the second conditional in Eq. (6) holding can be similarly verified.

Complementarity conditions are difficult to handle within optimization problems. A conventional approach relaxes the conditional statements

−2.38|T_{cl}−T_{z}|^{0.25}+12.1\sqrt{vₐᵣ}−λ+v=0

λ,z≧0,λz≦τ

v≧0,z≦1,v(1−z)≦τ

h_{c}=(2.38|T_{cl}−T_{z}|^{0.25})z+12.1\sqrt{vₐᵣ}(1−z) (15)

where τ>0 is a relaxation parameter. For all τ>0, Eq. (15) provides a strictly feasible interior to the optimization problems and continuous optimization can be readily applied. Because the smoothing parameter τ>0 has to be driven to zero to recover Eq. (6), the method solves a sequence of optimization problem where the value of the smoothing parameter is monotonically decreased. This provides an accurate method for handling the nonsmooth conditional in Eq. (6) and uses continuous optimization, which is computationally efficient.

A fourth approach to handle the conditionals in Eq. (6) is to simplify the equations. Typically, the temperature difference between the zone air and clothing in the room |T_{z}−T_{cl}| is less than 5 degrees C. Further, in air conditioned rooms, the relative velocity of the air vₐᵣ is typically 0.1 m/s. For these conditions, it can be assumed that the second conditional is satisfied and consequently, we simplify the conditionals in Eq. (6) as

h_{c}=12.1\sqrt{vₐᵣ}. (16)

Building Dynamics and Occupant Comfort Model

In the preferred embodiment, the dynamical model for a building includes N: rooms and N, walls represented as

$$\frac{d {T}_{z , i}}{d t} = {\sum }_{j : j \sim i}^{ } \frac{{T}_{w , j} - {T}_{z , i}}{{C}_{z , i} {R}_{zw , ij}} + \frac{{\dot{m}}_{vent , i} {C}_{p} ( {T}_{oa} - {T}_{z , i} )}{{C}_{z , i}} + \frac{{\dot{Q}}_{sen , i}}{{C}_{z , i}} + \frac{{\dot{Q}}_{sen , hvac , i}}{{C}_{z , i}} ∀ i = 1 , … , {N}_{z} , \qquad ( 17 )$$

where the differential variables the subscript i denotes a quantity associated with a room, subscript j denotes a quantity associated with a wall, subscript ij denotes a quantity associated with room i and wall j and notation j:i˜j denotes the set of (i,j) that such that room i has wall j. In the above, T_{z,i} represent the air temperature in room i, T_{w,j} represents the temperature of wall j, \dot{Q}_{sen,i} represents the rate of sensible heat generation from equipment, occupants and solar radiation through windows, \dot{Q}_{sen,hvac} represent the rate of sensible heating delivered by the air conditioner in room i, \dot{m}_{vent,i} is the ventilation air flow rate from room i, C_{z,i} is the heat capacity of air in room i and R_{zw,ij} is the resistance for heat transfer between air in room i and wall j.

The thermal dynamics of the wall in the building are represented as

$$\frac{d {T}_{w , j}}{d t} = {\sum }_{i : j \sim i}^{ } \frac{{T}_{z , i} - {T}_{w , j}}{{C}_{w , j} {R}_{zw , ij}} + \frac{{T}_{oa} - {T}_{w , j}}{{C}_{w , j} {R}_{woa , j}} + \frac{{\dot{Q}}_{ins , j}}{{C}_{w , j}} ∀ j = 1 , … , {N}_{w} , \qquad ( 18 )$$

where C_{w,j} represents the heat capacity of wall j, R_{woa,j} represents the resistance for heat transfer between the wall j and the outside air, \dot{Q}inv,i is the rate of heat gain on wall j from solar radiation, and notation i:i˜j denotes the set of (i,j) that such that room i has wall j.

The humidity dynamics of the rooms in the building are represented as

$$\frac{d {T}_{z , i}}{d t} = \frac{{\dot{m}}_{vent , i} ( {h}_{oa} - {h}_{z , i} )}{ρ {V}_{a , i}} + \frac{{\dot{Q}}_{lat , i}}{ρ {V}_{a , i} {L}_{v}} + \frac{{\dot{Q}}_{lat , hvac , i}}{ρ {V}_{a , i} {L}_{v}} ∀ i = 1 , … , {N}_{z} , \qquad ( 19 )$$

where h_{z,i} is the humidity of the air in room i, V_{a,i} is the volume of air in room i, \dot{Q}_{lat,i} is the rate of heat generated by equipment, occupants in room i, and \dot{Q}_{lat,hvac,i} is the rate of latent heat delivered by the air conditioner in room i.

The occupant comfort model for all rooms in the building is represented as

$$\begin{matrix}{PMV}_{i} = ( 0.303 {e}^{- 0.036 {M}_{i}} + 0.028 ) [ ( {M}_{i} - {W}_{i} ) - 3.05 \times {10}^{- 3} ( 5733 - 6.999 ( {M}_{i} - {W}_{i} ) - {p}_{a , i} ) - 0.42 ( ( {M}_{i} - {W}_{i} ) - 58.15 ) - 1.7 \times {10}^{- 5} {M}_{i} ( 5867 - {p}_{a , i} ) - 0.0014 {M}_{i} ( 34 - {T}_{z , i} ) - 3.96 \times {10}^{- 8} {f}_{cl , i} ( {( {T}_{cl , i} + 273.15 )}^{4} - {( {\overline{T}}_{r , i} + 273.15 )}^{4} ) - {f}_{cl , i} {h}_{c , i} ( {T}_{cl , i} - {T}_{z , i} ) ] & ( 20 ) \\ ∀ i = 1 , … , {N}_{z} , & \\ {T}_{cl , i} = 35.7 - 0028 ( {M}_{i} - {W}_{i} ) - 3.96 \times {10}^{- 8} {I}_{cl , i} {f}_{cl , i} ( {( {T}_{cl , i} + 273.15 )}^{4} - {( {\overline{T}}_{r , i} + 273.15 )}^{4} ) + {I}_{cl , i} {f}_{cl , i} {h}_{c , i} ( {T}_{cl , i} - {T}_{z , i} ) ∀ i = 1 , … , {N}_{z} , & ( 21 ) \\ {h}_{c , i} = \{ \begin{matrix}2.38 {\vert {T}_{cl , i} - {T}_{z , i} \vert}^{0.25} , if 2.38 {\vert {T}_{cl , i} - {T}_{z , i} \vert}^{0.25} > 12.1 \sqrt{{v}_{ar , i}} \\ 12.1 \sqrt{{v}_{ar , i}} , if 2.38 {\vert {T}_{cl , i} - {T}_{z , i} \vert}^{0.25} < 12.1 \sqrt{{v}_{ar , i}}\end{matrix} , & ( 22 ) \\ {f}_{cl , i} = \{ \begin{matrix}1.00 + 1.29 {I}_{cl , i} , & if {I}_{cl , i} \leq 0.078 \\ 1.05 + 0.645 {I}_{cl , i} , & if {I}_{cl , i} > 0.078\end{matrix} ∀ i = 1 , … , {N}_{z} , & ( 23 ) \\ {p}_{a , i} = \frac{{h}_{z , i}}{0.622 + {h}_{z , i}} {p}_{atm} ∀ i = 1 , … , {N}_{z} , & ( 24 )\end{matrix}$$

where for room i, PMVᵢ is the predicted mean vote index for occupants in the room, Mᵢ is the metabolic rate in (W/m²) for occupants in the room, Wᵢ is the effective mechanical power in (W/m²) in the room, I_{cl,i} is the clothing insulation in (m²K/W) in the room, f_{cl,i} is the clothing area factor in the room, T̅_{r,i} is the mean radiant temperature in the room, v_{ar,i} is the relative air velocity in the room in (m/s), h_{c,i} is the convective heat transfer coefficient in (W/m²/K), p_{a,i} is the water vapor partial pressure in (atm) in the room, T_{cl,i} is the clothing surface temperature in the room.

HVAC Outdoor and Indoor Unit

In the preferred embodiment, the outdoor and indoor units are modeled as

$${P}_{hvac} = {a}_{0} + {a}_{1} * {T}_{oa} + {a}_{2} * Cf \\ {\dot{Q}}_{all , hvac} = {b}_{0} + {b}_{1} * {T}_{oa} + {b}_{2} * {C}_{f} \\ {X}_{cond} = \frac{Δ X}{Δ H} {\dot{Q}}_{all , hvac} \\ Δ X = \frac{{\sum }_{i = 1}^{{N}_{z}} {\dot{m}}_{hvac , i} {h}_{z , i} - {\sum }_{i = 1}^{{N}_{z}} {\dot{m}}_{hvac , i} {h}_{out}}{{\sum }_{i = 1}^{{N}_{z}} {\dot{m}}_{hvac , i}} \\ {RH}_{out} = \frac{{h}_{out}}{0.622 + {h}_{out}} \\ Δ H = {\sum }_{i = 1}^{{N}_{z}} {\dot{m}}_{hvac , i} {H}_{z , i} - {\sum }_{i = 1}^{{N}_{z}} {\dot{m}}_{hvac , i} {H}_{z , out} \\ {H}_{z , i} = {C}_{p} {T}_{z , i} + {h}_{z , i} ( {C}_{pw} {T}_{z , i} + {L}_{v} ) \\ {H}_{z , out} = {C}_{p} {T}_{z , i} + {h}_{z , out} ( {C}_{pw} {T}_{out} + {L}_{v} ) \\ {T}_{out} = ( 1 - BPF ) * {T}_{cond} + \frac{{\sum }_{i = 1}^{{N}_{z}} {\dot{m}}_{hvac , i} {T}_{z , i}}{{\sum }_{i = 1}^{{N}_{z}} {\dot{m}}_{hvac , i}} \\ {\dot{Q}}_{sen , hvac , i} = {\dot{m}}_{hvac , i} {C}_{p} {T}_{out} ∀ i = 1 , … , {N}_{z} \\ {\dot{Q}}_{lat , hvac , i} = {\dot{m}}_{hvac , i} {h}_{out} ( {C}_{p} {T}_{out} + {L}_{v} ) ∀ i = 1 , … , {N}_{z} , \qquad ( 25 )$$

where, P_{hvac} is the amount of electric power consumed by the HVAC outdoor unit, \dot{Q}_{all,hvac} is the total heating delivered by the HVAC unit, Cf is the compressor frequency of the HVAC unit, a₀, a₁, a₂, b₀, b₁, b₂ are constants, X_{cond} is the amount of condensation in the outdoor unit, ΔX is the difference in specific humidity between the inlet and outlet of the outdoor unit, \dot{m}_{hvac,i} is the mass flow rate of air from the room air conditioners, hₒᵤₜ is the specific humidity of air at outlet of outdoor unit, RHₒᵤₜ is the relative humidity of air at outlet of outdoor unit, ΔH is the difference in specific enthalpy between the inlet and outlet of the outdoor unit, H_{z,i} is the specific enthalpy of the return air from the air conditioner in room i, Hₒᵤₜ is the specific enthalpy of the air supplied by the outdoor unit to the rooms, BPF is the bypass factor of the outdoor unit, T_{cond} is the condensation temperature at the outdoor unit.

Typically, RHₒᵤₜ is selected to 95%, BPF is selected to 0.2 and T_{cond} is selected to 5 deg C.

The model in Eq. (25) applies for a single outdoor unit, and can be extended to the case of multiple outdoor units.

Comfort Optimization Formulation

In the preferred embodiment, the optimization minimizes the electric power consumption of the outdoor unit as,

$$\begin{matrix}min {\int }_{0}^{T} {P}_{hvac} d t & ( 26 ) \\ \begin{matrix} & Eq . ( 17 ) \text{-} ( 19 ) , Eq . ( 20 ) \text{-} ( 21 ) , ( 23 ) , ( 24 ) , ( 25 ) \\ s . t . & {h}_{c , i} = \frac{1}{2} ( \begin{matrix}2.38 {\vert {T}_{cl , i} - {T}_{z , i} \vert}^{0.25} + 12.1 \sqrt{{v}_{ar , i}} + \\ \sqrt{{( 2.38 {\vert {T}_{cl , i} - {T}_{z , i} \vert}^{0.25} - 12.1 \sqrt{{v}_{ar , i}} )}^{2} + {τ}^{2}}\end{matrix} ) \\ & ∀ i = 1 , … , {N}_{z} such that\end{matrix} \} & \\ ∀ t ∈ [ 0 , T ] \\ Initial condition for room temperatu res , \\ humidity and wall temperatu res \\ \begin{matrix}\begin{matrix}Bounds on {PMV}_{i} ∀ i = 1 , … , {N}_{z} \\ Bounds on Cf , {\dot{m}}_{hvac , i}\end{matrix} \\ Physical bounds on variabl es\end{matrix} \} ∀ t ∈ [ 0 , T ] . & \end{matrix}$$

In Eq. (26), a smoothing formulation is used to model the conditional statements in the PMV calculation. The comfort requirement is formulated as upper and lower limits on the PMV for each room. The values of +0.5 and −0.5 are typically used when the building is occupied. The compressor frequency is limited to be within 10 Hz˜80 Hz, and the mass flow rates are also limited based on the capacity of the fans in the individual air conditioning units. In addition, limits such as non-negativity of temperatures, humidity and other quantities from physical considerations are included in the optimization formulation.

There are a number of parameters whose values for the period of the optimization are provided. These parameters are:
(Q_{ins,1}, . . . , Q_{ins,N}_{_{w}}, Tₒₐ, hₒₐ, M₁, W₁, I_{cl,1}, v_{ar,1}, \dot{Q}_{sen,occ,1}, \dot{Q}_{lat,occ,1}, . . . , M_{N}_{_{z}}, W_{N}_{_{z}}, I_{cl,N}_{_{z}}, V_{ar,N}_{_{z}}, \dot{Q}_{sen,occ,N}_{_{z}}, \dot{Q}_{lat,occ,N}_{_{z}}).

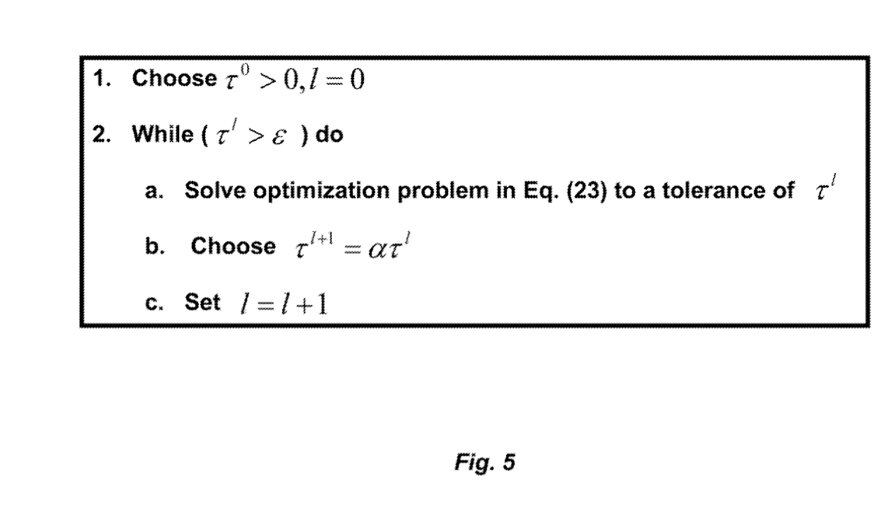

As described above, the minimization problem in Eq. (26), based on smoothing formulation, is well behaved for τ>0, but the smoothing parameter has to be decreased to 0 to recover a solution to the original problem. The procedure for solving this problem is shown in FIG. 5.

For simplicity of this description, the building dynamics model is represented as

$$\begin{matrix}\frac{d x}{d t} = {f}^{diff} ( x ( t ) , y ( t ) , u ( t ) , d ( t ) ) \\ {f}^{a lg} ( x ( t ) , y ( t ) , u ( t ) , d ( t ) ) = 0\end{matrix} \} ∀ t ∈ [ 0 , T ] \\ ( x ( 0 ) , y ( 0 ) ) = ( \hat{x} , \hat{y} ) , \qquad ( 27 )$$

where x the set of differential variables corresponds to
(T_{z,1}, h_{z,1}, . . . , T_{z,N}_{_{z}}, h_{z,N}_{_{z}}, T_{w,1}, . . . , T_{w,N}_{_{w}}), y
   the set of algebraic variables corresponds to
(PMV₁, T_{cl,1}, T̅_{r,1}, h_{c,1}, p_{a,1}, \dot{Q}_{sen,hvac,1}, \dot{Q}_{lat,hvac,1}, . . . , PMV₁, T_{cl,N}_{_{z}}, T̅_{r,N}_{_{z}}, h_{c,N}_{_{z}}, p_{a,N}_{_{z}}, \dot{Q}_{sen,hvac,N}_{_{z}}, \dot{Q}_{lac,hvac,N}_{_{z}}),
   u the set of control variables corresponds to
(Cf, \dot{m}_{hvac,1}, . . . , \dot{m}_{hvac,N}_{_{z}}),
   and d the set of time dependent parameters
(Q_{ins,1}, . . . , Q_{ins,N}_{_{w}}, Tₒₐ, hₒₐ, M₁, W₁, I_{cl,1}, v_{ar,1}, . . . , M_{N}_{_{z}}, W_{N}_{_{z}}, I_{cl,N}_{_{z}}, v).

The differential equations correspond to Equations (17)-(19). The algebraic equations correspond to Equations (20)-(21), (23)-(25) and the smoothing formulation (26). With this representation, the optimization problem in Eq. (26) can be recast as

$$\begin{matrix}min {\int }_{0}^{T} c ( x , y , u ) d t & ( 28 ) \\ s . t . \begin{matrix}\frac{d x}{d t} = {f}^{diff} ( x ( t ) , y ( t ) , u ( t ) , d ( t ) ) \\ {f}^{a 1 g} ( x ( t ) , y ( t ) , u ( t ) , d ( t ) ) = 0\end{matrix} \} ∀ t ∈ [ 0 , T ] \\ ( x ( 0 ) , y ( 0 ) ) = ( \hat{x} , \hat{y} ) \\ \begin{matrix}\begin{matrix}\underline{x} ( t ) \leq x ( t ) \leq \overline{x} ( t ) \\ \underline{y} ( t ) \leq y ( t ) \leq \overline{y} ( t )\end{matrix} \\ \underline{u} ( t ) \leq u ( t ) \leq \overline{u} ( t )\end{matrix} \} ∀ t ∈ [ 0 , T ] , & \end{matrix}$$

where x, x̅ are lower and upper limits on differential variables, y, y̅ are lower and upper limits on algebraic variables and u, ū Tare lower and upper limits on the controls.

The limits are assumed to be function of time because different bounds can be specified based on the occupancy conditions. The optimization problem in Eq. (28) is an instance of optimal control problem. These problems are generally solved by discretizing the differential and algebraic equations, which are now imposed at a finite set of time instances instead of all time instants in [0, T].

Discretization schemes, such as the explicit Euler, implicit Euler, Runge-Kutta methods, or collocation schemes can be used. With such a discretization, the problem in Eq. (28) is reduced to a nonlinear program with finite number of variables and constraints.

In the preferred embodiment, the optimal control problem is Eq. (28) is discretized using an implicit Euler scheme as

$$min Δ t {\sum }_{k = 1}^{{N}_{T}} c ( {x}_{k} , {y}_{k} , {u}_{k} ) \\ \begin{matrix}s . t . & \frac{{x}_{k} - {x}_{k - 1}}{Δ t} = {f}^{diff} ( {x}_{k} , {y}_{k} , {u}_{k} , {d}_{k} ) ∀ k = 1 , … , {N}_{T} \\ & 0 = {f}^{a 1 g} ( {x}_{k} , {y}_{k} , {u}_{k} , {d}_{k} ) ∀ k = 1 , … , {N}_{T} \\ & ( {x}_{0} , {y}_{0} ) = ( \hat{x} , \hat{y} ) \\ & \begin{matrix}\begin{matrix}{\underline{x}}_{k} \leq {x}_{k} \leq {\overline{x}}_{k} \\ {\underline{y}}_{k} \leq {y}_{k} \leq {\overline{y}}_{k}\end{matrix} \\ {\underline{u}}_{k} \leq {u}_{k} \leq {\overline{u}}_{k}\end{matrix} \} ∀ k = 1 , … , {N}_{T} ,\end{matrix} \qquad ( 29 )$$

where Δt is the time step of the discretization and N_{T}=T/Δt are the number of discretization steps in the optimization. The optimization problem in Eq. (29) is very sparse and appropriate use of spare linear algebra can reduce the computational complexity.

In the preferred embodiment, the optimization problem in (29) is solved using nonlinear programming algorithms that use sparse linear algebra techniques.

In another embodiment the conditional equations in PMV calculation is formulated using complementarity constraints

$$min {\int }_{0}^{T} {P}_{hvac} d t \\ \begin{matrix} & Eq . ( 17 ) \text{-} ( 19 ) , Eq . ( 20 ) \text{-} ( 21 ) , ( 23 ) , ( 24 ) , ( 25 ) \\ & - 2.38 {\vert {T}_{cl , i} - {T}_{z , i} \vert}^{0.25} + 12.1 \sqrt{{v}_{ar , i}} - {λ}_{i} + {v}_{i} = 0 \\ & {λ}_{i} , {z}_{i} \geq 0 , {λ}_{i} {z}_{i} \leq τ \\ & 1 - {z}_{i} , {v}_{i} \geq 0 , ( 1 - {z}_{i} ) {v}_{i} \leq τ \\ s . t . & {h}_{c , i} = ( 2.38 {\vert {T}_{cl , i} - {T}_{z , i} \vert}^{0.25} ) {z}_{i} + 12.1 \sqrt{{v}_{ar , i}} ( 1 - {z}_{i} ) \\ & ∀ i = 1 , … , {N}_{z} such that\end{matrix} \} \begin{matrix} \\ \\ \\ \\ \end{matrix} \\ ∀ t ∈ [ 0 , T ] \\ Initital condition for room temperatu res , \\ humidity and wall temperatu res \\ \begin{matrix}\begin{matrix}Bounds on {PMV}_{i} ∀ i = 1 , … , {N}_{z} \\ Bounds on Cf , {m}_{hvac , i}\end{matrix} \\ Physical bounds on variabl es\end{matrix} \} ∀ t ∈ [ 0 , T ] \qquad □$$

In another embodiment, the conditional equations in PMV calculation is formulated using binary variables as the Mixed Integer Nonlinear Programming (MINLP)

$$min {\int }_{0}^{T} {P}_{hvac} d t \\ \begin{matrix} & Eq . ( 14 ) \text{-} ( 16 ) , Eq . ( 17 ) \text{-} ( 19 ) , ( 20 ) , ( 21 ) , ( 22 ) \\ & \begin{matrix}\begin{matrix}{z}_{i} ∈ \{ 0 , 1 \} \\ 2.38 {\vert {T}_{cl , i} - {T}_{z , i} \vert}^{0.25} \geq ( 12.1 \sqrt{{v}_{ar , i}} ) {z}_{i}\end{matrix} \\ {h}_{c , i} = ( 2.38 {\vert {T}_{cl , i} - {T}_{z , i} \vert}^{0.25} ) \geq ( 12.1 \sqrt{{v}_{ar , i}} ) ( 1 - {z}_{i} )\end{matrix} \} \\ & \begin{matrix} & ∀ 1 = 1 , … , {N}_{z}\end{matrix}\end{matrix} \} \\ s . t . ∀ t ∈ [ 0 , T ] \\ min {\int }_{0}^{T} {P}_{hvac} d t \\ \begin{matrix} & Initial condition for room temperatu res , \\ s . t . & humidity and wall temperatu res \\ & Bounds on {PMV}_{i} ∀ i = 1 , … , {N}_{z} \\ & Bounds on Cf , {\dot{m}}_{hvac , i} \\ & Physical bounds on variabl es\end{matrix} \} ∀ t ∈ [ 0 , T$$

In another embodiment, comfort optimization is formulated using simplification of the conditional equations in PMV calculation as,

$$min {\int }_{0}^{T} {P}_{hvac} d t \\ \begin{matrix}\begin{matrix}Eq . ( 14 ) \text{-} ( 16 ) \\ Eq . ( 17 ) \text{-} ( 19 ) , ( 20 ) , ( 21 ) , ( 22 )\end{matrix} \\ {h}_{c , i} = 12.1 \sqrt{{v}_{ar , i}} ∀ 1 = 1 , … , {N}_{z}\end{matrix} \} ∀ t ∈ [ 0 , T ]$$

$$\begin{matrix}s . t . & Initial condition for room temperature , \\ & humidity and wall temperatures \\ & \begin{matrix}Bounds on {PMV}_{i} ∀ i = 1 , … , {N}_{z} \\ Bounds on Cf , {\dot{m}}_{hvac , i} \\ Physical bounds on variables\end{matrix} \} ∀ t ∈ [ 0 , T ]\end{matrix}$$

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for optimizing a heating, ventilation and air-conditioning (HVAC) system for a building while maximizing a comfort of occupants and minimizing energy consumption, comprising the steps of:
modeling the building as a network of nodes and edges, wherein the nodes represent rooms, and the edges represent walls;
modeling dynamics of temperatures and humidity in the rooms and the temperature of the walls and the building using differential equations and the network;
modeling the comfort of the occupants by a predicted mean vote (PMV);
formulating the minimizing as an optimal control problem;
discretizing the optimal control problem using an integration technique to obtain a finite dimensional optimization problem; and
solving the finite dimensional optimization problem using sparse linear algebra until convergence, wherein the steps are performed in a processor.

2. The method of claim 1, further comprising:
modeling dynamics of the building using a linear resistive-capacitive network.

3. The method of claim 1, wherein the discretizing is performed using an explicit Euler method.

4. The method of claim 1, wherein the discretizing is performed using an implicit Euler method.

5. The method of claim 1, wherein the discretizing is performed using an implicit Runge-Kutta method.

6. The method of claim 1, wherein the discretizing is performed using collocation on finite elements.

7. The method of claim 1, further comprising:
maximizing the comfort by smoothing of conditional statements in the PMV uses a smoothing parameter;
discretizing using an implicit Euler method to obtain a finite dimensional nonlinear program; and
solving the finite dimensional nonlinear program for a fixed value of the smoothing parameter with a nonlinear optimization procedure that uses sparse linear algebra, and repeating the steps for a sequence of decreasing values of smoothing parameter until convergence.

8. The method of claim 1, wherein the comfort is formulated by conditional statement in the PMV using a binary variables;
discretizing the optimal control problem using Implicit Euler technique to obtain a finite dimensional mixed integer nonlinear program; and
solving a mixed integer nonlinear program using an algorithm that employs sparse linear algebra techniques for computational efficiency and repeating the steps for a sequence of decreasing values of smoothing parameter until convergence.

9. The method of claim 1, wherein the comfort is modeled by simplifying conditional statement in PMV to one of conditions;
discretizing using an implicit Euler method to obtain a finite dimensional nonlinear program; and
solving the finite dimensional nonlinear program nonlinear using sparse linear algebra until convergence.

10. The method of claim 1, wherein the comfort is achieved by relaxation of complementarity constraint modeling of conditional statements in the PMV uses a parameter;
discretizing using an implicit Euler method to obtain a finite dimensional nonlinear program; and
solving the finite dimensional nonlinear program for a fixed value of the relaxation parameter with a nonlinear optimization procedure that uses sparse linear algebra, and repeating the steps for a sequence of decreasing values of relaxation parameter until convergence.
